(19) United States
(12) Patent Application Publication
(10) Pub. No.: US 2006/0114868 A1
(43) Pub. Date: Jun. 1, 2006

(54) MGW codec information managing method in MSC server

(75) Inventor: Sung-Kyun Park, Gyeonggi-Do (KR)

Correspondence Address: JONATHAN Y. KANG, ESQ;LEE & HONG P.C., 14th Floor, 801 S. Figueroa Street, Los Angeles, CA, 90017, US

(73) Assignee: LG Electronics Inc.

(21) Appl. No.: 11/287,081

(22) Filed: Nov. 23, 2005

(30) Foreign Application Priority Data
Nov. 26, 2004 (KR) 10-2004-97935

(51) Int. Cl. H04Q 7/24; H04L 12/56; H04L 12/28

(52) U.S. Cl. 370/338; 370/401; 370/410

(57) ABSTRACT

A method for managing codec information of Media Gateways (MGWS) in a Mobile Switching Center (MSC) server, comprising receiving a registration request from at least one or more MGWs, registering the request MGW, and transmitting a codec information request message to the registered MGW to thus update MGW codec information that the MSC server itself manages using the codec information received from the MGW.

### CROSS REFERENCE TO RELATED APPLICATION

Pursuant to 35 U.S.C. § 119(a), this application claims the benefit of earlier filing date and right of priority to Korean Application No. 10-2004-0097935, filed Nov. 26, 2004, the contents of which are hereby incorporated by reference herein in their entirety.

### BACKGROUND OF THE INVENTION

1. Field of the Invention

The present invention relates to an information managing method of a Mobile Switching Center (MSC) server, and particularly, to a codec information managing method Media GateWays (MGWs) in a MSC server.

2. Background of the Related Art

In general, a Universal Mobile Telecommunication System (UMTS) is a European-type third generation mobile communications system that has evolved from a Global System for Mobile communication (GSM). The UMTS is intended to provide various mobile communication services by combining Radio Access Network (RAN) with Wideband Code Division Multiple Access (W-CDMA) based on the GSM.

The specification of the UMTS is currently being developed by a standardization group called as a Third Generation Partnership Project (3GPP). The 3GPP proposes standardization that has been stepwise developed to include more improved functions, and each development step for the standardization is divided as Release (R). Among them, in a 3GPP R4, a Mobile Switching Center/Visitor Location Resister (MSC/VLR) which is a core network node belonging to a circuit switched region is divided into Mobile Switching Center (MSC) servers and Media Gateways (MGWs).

FIG. 1 is a view illustrating an exemplary structure of UMTS system described in a typical 3GPP R4.

As illustrated in FIG. 1, the MSC server 10 is connected to the MGW 20 via an Mc interface. The MSC servers 10 are connected therebetween via an Nc interface, while the MGWs 20 are connected therebetween via an Nb interface. The MSC server 10 or the MGW 20 is connected to a Universal Mobile Telecommunications System Radio Access Network (UTRAN) via an lu interface. The MSC 10 and the MGW 20 may be connected to a Public Switching Telephone Network (PSTN) as well. Here, the UTRAN may include a Radio Network Controller (RNC) 30 and a user terminal (User Equipment: UE) 40. The MSC server 10 uses a Media Gateway Control (MEGACO, ITU name is H.248) as a protocol for controlling the MGW 20.

The MSC server 10 includes a VLR function to perform a management of mobility of a terminal and a control for the MGW 20. Also, the MSC servers 10 are connected to each other using a Bearer Independent Call Control (BICC), which is a signal protocol spec between soft switches to perform a transferring of a call signal and a voice data in a public telephone network or an intelligent network to a packet-based communications network. The BICC is used for an interworking between soft switches which are used to create a next generation network. Further, the MSC server 10 is connected to the RNC 30 via a Radio Access Network Application Part (RANAP).

The MGW 20 performs a substantial switching function and an InterWorking (I/W) function of a network, and so on. The MGW 20 may additionally perform a function such as performing a conversion of a Voice over Internet Protocol (VoIP) call into a circuit switched packet as well as functions as a transcoder, an echo cancellation, a modem, and the like. A CN bearer between MGWs 20 and an lu bearer between the MGW 20 and the RNC 30 perform a signal processing using AAL2 and ALCAP. The RNC 30 is connected to the UE 40 via a radio bearer.

A MGW codec information managing method in the UMTS system of 3GPP R4 having such construction will now be explained.

Referring to FIG. 1, when a call is established between two terminals 40, each MGW 20 generates a logical entity referred to as a termination for processing the corresponding call, and switches corresponding terminations to thus communicate between the two terminals 40. At this time, the MSC server 10 must manage information of Coder and Decoder (Codec) of the MGW 20 in order to perform a Transcoder Free Operation (TrFO) function. Here, the termination refers to a logical entity for indicating a media stream used in each MGW 20.

The TrFO function refers to a function of matching codec information of a plurality of MGWs 20, namely, a function of preventing a transcoder from being used as much as possible. That is, if each MGW 20 supports several codec, codec information of each MGW 20 is previously determined in order to fully select the same codec, and accordingly negotiation is progressed to select the best operating codec, such function being referred to as the TrFO. Therefore, the MSC server 10 performs the codec function together with the control function, and the MGW 20 performs the switching function of an actual termination.

Accordingly, in the related art, the codec negotiation has been performed upon performing the TrFO function after creating codec information to be used between the MSC server and the MGW by a data process in a system. That is, the MSC server 10 performs the codec negotiation from a sending end to a receiving end using the codec information to match codec information between terminations used in each MGW 20, thereby preventing the transcoder from being used.

However, because the 3GPP standardization has not defined how to manage the codec information of MGW, the codec information has been managed by an individual operator. As a result, when the codec information of the MGW is varied, the operator had to manually match codec information of each MGW to match information between systems. Thus, in the related art, when the operator did not update the codec information of each MGW by mistake, the codec selected by the codec negotiation could not be used in the MGW.

### BRIEF DESCRIPTION OF THE INVENTION

Therefore, an object of the present invention is to provide a method for efficiently managing codec information of a MGW.

To achieve these and other advantages and in accordance with the purpose of the present invention, as embodied and broadly described herein, there is provided a MGW codec information managing method in a Mobile Switching Center (MSC) server which interworks with at least one or more Media GateWays (MGWs), the method comprising receiving a registration request from a MGW, registering the requested MGW, transmitting a codec information request message to the registered MGW to update MGW codec information using the codec information received from the corresponding MGW.

Preferably, the MGW codec information is codec information used in each MGW.

Preferably, the codec information request message is an AuditValue message used when the MSC server desires to know information with respect to a termination.

Preferably, the codec information request message is constructed when a MGW is registered, the MSC server creates a new codec type using a Man Machine Command (MMC) command, or an operator manually requests an updating of the MGW codec information.

The updating of the MGW codec information in the MGW codec information managing method may comprise a MMC command processing unit requesting the updating of the codec information from a MEGACO processing unit, the MEGACO processing unit transmitting the codec information request message to the MGW, the MGW transmitting a codec information reply message to the MEGACO processing unit, the MEGACO processing unit updating the codec information used in each MGW using several codec information contained in the codec information reply message, and notifying a completion of the codec information updating to the MMC command processing unit when the codec information is completely updated.

Preferably, the codec information updating request is transmitted when the MGW is registered, the MMC command processing unit generates a new codec type, or an operator requests the updating of the codec information.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a schematic view illustrating an exemplary construction of a typical UMTS system described in a 3GPP R4;

FIG. 2 is a block diagram illustrating an interworking between a MSC server and a plurality of MGWs;

FIG. 3 is a flow chart illustrating sequential steps of an exemplary MGW codec information managing method in a MSC server according to the present invention;

FIG. 4 is a signal flow chart illustrating a MGW codec information managing method when a MSC server interworks with a plurality of MGWs;

FIG. 5 is a view illustrating an exemplary construction of an AuditValue request message and an AuditValue reply message used in the present invention; and

FIG. 6 is a signal flow chart illustrating an exemplary operation of each block within a MSC server when a MSC server manages MGW codec information

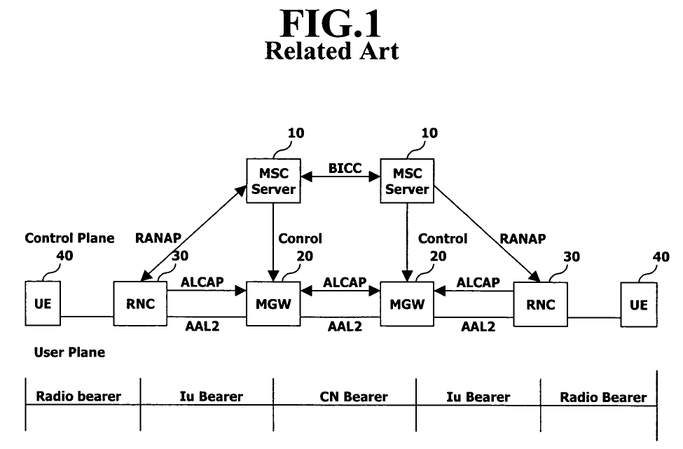

### DETAILED DESCRIPTION OF THE INVENTION

Reference will now be made in detail to the preferred embodiments of the present invention, examples of which are illustrated in the accompanying drawings.

The present invention is directed to a method for managing codec information of a plurality of MGWs in a MSC server, the MSC server interworking with the plurality of MGWs.

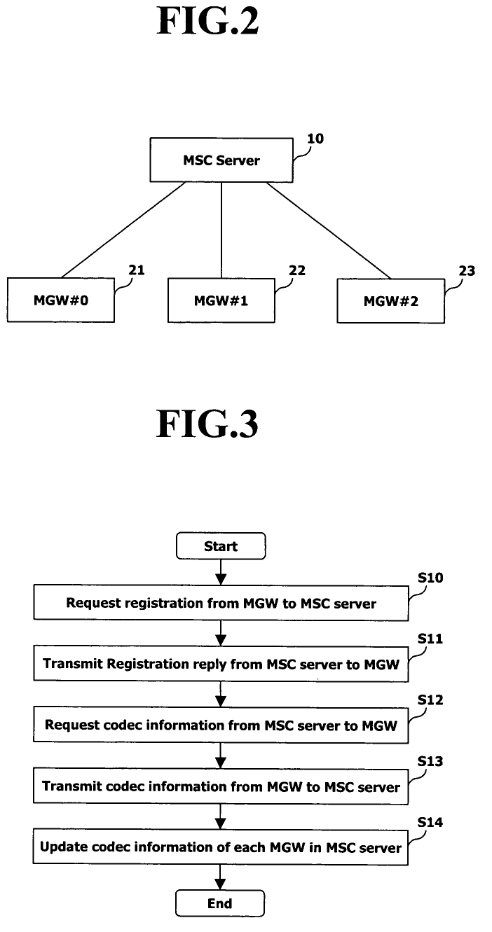

Referring to FIG. 2, for example, a MGW 21 initially accesses the MSC server 10 interworking therewith, and performs a registration process. Upong completing the registration process, the MSC server 10 transmits an AuditValue message to the MGW 21 to receive codec information of the MGW 21 therefrom. Such operations are repeatedly performed, so as to match codec information according to MGWs 21, 22 and 23. Here, the AuditValue denotes a message (or a command) used to recognize information with respect to a termination of the MGW.

FIG. 3 is a flow chart illustrating an exemplary MGW codec information managing method in a MSC server according to the present invention.

Referring to FIG. 3, first, the MGW 20 initially accesses the MSC server 10, and requests its registration from the MSC server 10 (S10). When the MGW 20 requests its registration, the MSC server 10 transmits a registration reply message to the MGW 20(S11), and then requests codec information from the MGW 20 using the AuditValue message transmitted between the MSC server 10 and the MGW 20(S12).

The MGW 20 replies to the codec information request of the MSC server 10 to thus transmit its codec information to the MSC server 10(S13). The MSC server 10 then uses the received codec information of the MGW 20 to update the MGW codec information that the MSC server itself manages (S14).

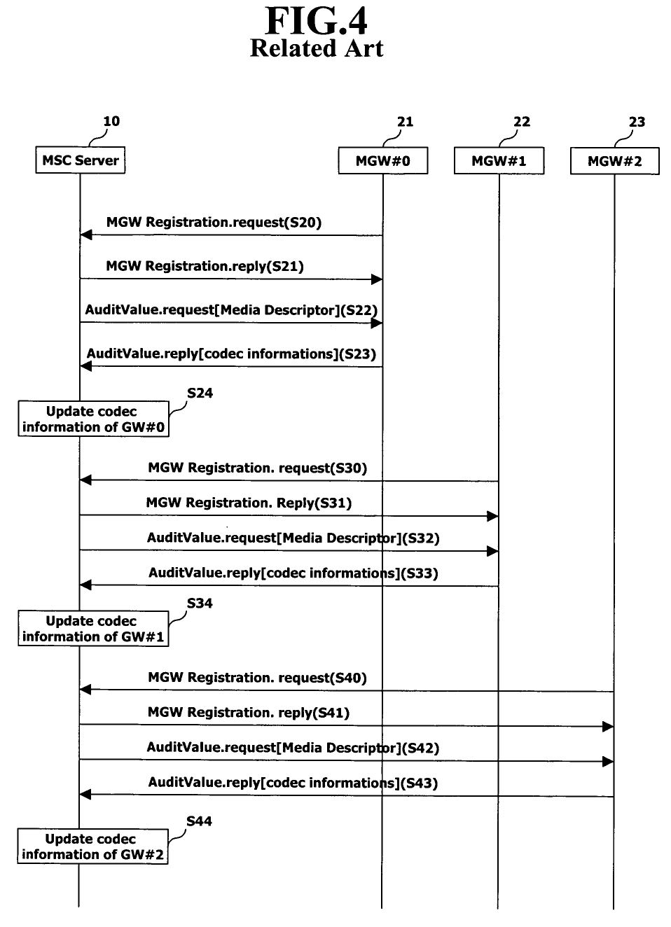

FIG. 4 is a signal flow chart illustrating a MGW codec information managing method when the MSC server interworks with a plurality of MGWs in the present invention.

When the MGW#0 21 initially accesses the MSC server 10, the MGW#0 21 transmits a MGW registration request message to the MSC server 10 to request its registration therein (S20). The MSC server 10 registers the MGW#0 21 therein to thereafter transmit a MGW registration reply message to the MGW#0 21 (S21).

Upon completing the registration process, the MSC server 10 transmits an AuditValue request message to the MGW#0 21 to request its codec information (S22). The MGW#0 21 transmits its codec information to the MSC server 10 using an AuditValue reply message (S23).

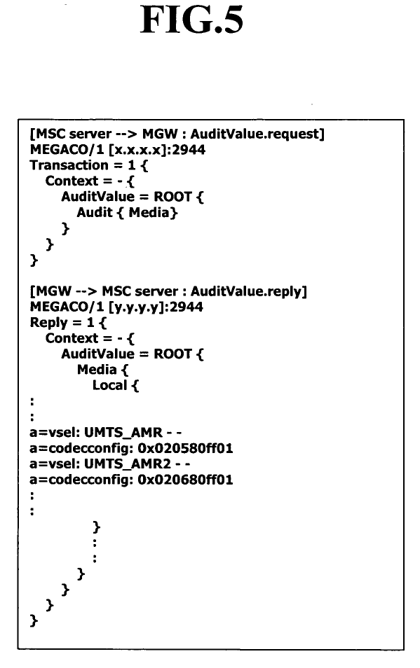

Accordingly, the MSC server 10 uses the received codec information of the MGW#0 21 to update the MGW codec information that the MSC server 10 itself manages (S24). FIG. 5 illustrates an exemplary construction of the AuditValue request message and the AuditValue reply message.

When MGW#1 22 and MGW#2 23 initially access the MSC server 10, the same operation as that of the MGW#0 21 is performed. That is, when the MGW#1 22 initially accesses the MSC server 10, the MGW#1 performs the registration process into the MSC server 10 (S30 and S31). When the registration process is completed, the MSC server 10 transmits the AuditValue request message to the MGW#1 22 to request the codec information of the MGW#1 22 (S32). The MGW#1 22 then transmits its codec information to the MSC server 10 using the AuditValue reply message (S33). The MSC server 10 thus uses the received codec information of the MGW#1 22 to update the MGW codec information that the MSC server 10 itself manages (S34).

When the MGW#2 23 initially accesses the MSC server 10, the MGW#2 23 also performs the registration process into the MSC server 10 (S40 and S41). When the registration process is completed, the MSC server 10 transmits the AuditValue request message to the MGW#2 23 to request the codec information of the MGW#2 23 (S42). The MGW#2 23 transmits its codec information to the MSC server 10 using the AuditValue reply message (S43). The MSC server 10 thus uses the received codec information of the MGW#2 23 to update the MGW codec information that the MSC server 10 itself manages (S44). That is, the MSC server 10 performs such processes to match codec information of the MGWs 21, 22 and 23 that it manages.

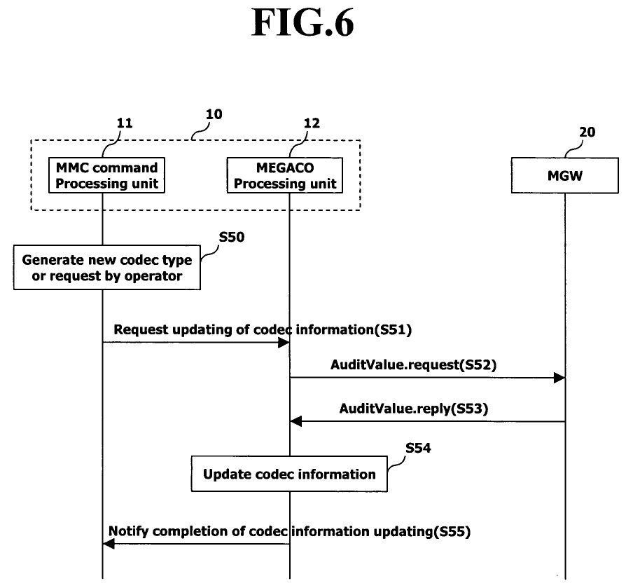

FIG. 6 is a signal flow chart illustrating an exemplary operation of each block within the MSC server when the MSC server manages the MGW codec information. Here, the reference numeral 11 denotes a Man Machine Command (MMC) command processing unit, and the reference numeral 12 denotes a Media Gateway Control (MEGACO) processing unit.

As illustrated in FIG. 6, after registering the MGW, when the MSC server 10 generates new codec information (a new codec type) using a MMC command or an operator manually requests an updating of the MGW codec information, the MMC command processing unit 11 requests the updating of the codec information from the MEGACO processing unit 12 (S50 and S51). The MEGACO processing unit 12 transmits the AuditValue request message to the MGW 20 in response to the updating request. At this time, a codec type which is actually used among the generated codec types is updated based on the codec information received from each MGW.

The MGW 20 having received the AuditValue request message transmits the AuditValue reply message containing its codec information to the MEGACO processing unit 12 of the MSC server 10 (S53). The MEGACO processing unit 12 updates the MGW codec information (S54), and then notifies the MMC command processing unit 11 that the MGW codec information is completely updated (S55).

Accordingly, the MSC server 10 may generate codec types that it manages, and the corresponding (generated) codec types can be updated to be used by receiving the codec information from each MGW 20. That is, when the MSC server performs the TrFO function, the MSC server 10 automatically manages codec information that the MGW interworking with the MSC server 10 can support.

As described above, in the present invention, when the MSC server performs the TrFO function, the MSC server automatically manages the codec information that the MGW interworking with the MSC server 10 can support, whereby the codec information can be conveniently used and shortcomings caused in the related art when the operator did not update the codec information can be effectively prevented.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

What is claimed is:

1. A Media Gateway (MGW) codec information managing method in a Mobile Switching Center (MSC) server which interworks with at least one or more MGWs, comprising:
receiving a registration request from the MGW;
registering the requested MGW; and
transmitting a codec information request message to the registered MGW, and thus updating MGW codec information using the codec information received from the corresponding MGW.

2. The method of claim 1, wherein the MGW codec information is codec information used in each MGW.

3. The method of claim 1, wherein the codec information request message is a message used when desiring to know information with respect to a termination of the MGW.

4. The method of claim 3, wherein the codec information request message is an AuditValue.

5. The method of claim 1, wherein the codec information request message is created when the MGW is registered, the MSC server generates a new codec type using a Man Machine Command (MMC) command, or an operator manually requests an updating of the MGW codec information.

6. The method of claim 1, wherein the updating includes:
requesting the updating of the codec information from a Media Gateway Control (MEGACO) processing unit by a Man Machine Command (MMC) command processing unit;
transmitting a codec information request message to the MGW by the MEGACO processing unit;
transmitting a codec information reply message to the MEGACO processing unit by the MGW;
using codec information contained in the codec information reply message, by the MEGACO processing unit, to update the codec information used in each MGW; and
notifying the MMC command processing unit of a completion of the updating of the codes information when the codec information is completely updated.

7. The method of claim 6, wherein the codec information updating request is transmitted when the MGW is registered, the MMC command processing unit generates a new codec type, or an operator requests the updating of the codec information.
